(19) United States
(12) Patent Application Publication
(10) Pub. No.: US 2018/0118912 A1
(43) Pub. Date: May 3, 2018

(54) CARBON AEROGELS VIA POLYHEXAHYDROTRIAZINE REACTIONS

(71) Applicant: International Business Machines Corporation, Armonk, NY (US)

(72) Inventors: Dylan J. BODAY, Austin, TX (US); Jeannette M. GARCIA, San Leandro, CA (US); James L. HEDRICK, Pleasanton, CA (US); Jason T. WERTZ, Pleasant Valley, NY (US); Rudy J. WOJTECKI, San Jose, CA (US)

(21) Appl. No.: 15/339,518

(22) Filed: Oct. 31, 2016

(51) Int. Cl. C08J 9/36; C08J 9/12; C08J 9/28

(52) U.S. Cl. CPC C08J 9/36; C08J 9/122; C08J 2203/06; C08J 2379/04; C08J 2205/026; C08J 9/286

(57) ABSTRACT

An aerogel is disclosed that includes polyhexahydrotriazine and/or polyhemiaminal species. Methods of making such an aerogel are also described.

### BACKGROUND

Apparatus and methods described herein relate to carbon aerogels and methods of making carbon aerogels.

### SUMMARY

Embodiments described herein provide an aerogel that is a carbonization product comprising a polymer with a plurality of hexahydrotriazine groups and a plurality of linking groups, each linking group covalently bonded to two hexahydrotriazine groups.

Other embodiments described herein provide an aerogel comprising a polymer with a plurality of cyclic hemiaminal groups and a plurality of linking groups, each linking group covalently bonded to a pair of hemiaminal groups.

Other embodiments described herein provide a method of making an aerogel, comprising reacting a primary diamine and a formaldehyde in a solvent to form a polymer having repeated cyclic structures; subjecting the polymer to a supercritical CO₂ solvent removal process; and thermally hardening the polymer to form an aerogel.

### BRIEF DESCRIPTION OF THE SEVERAL VIEWS OF THE DRAWINGS

FIG. 1 is a flow diagram summarizing a method according to one embodiment.

### DETAILED DESCRIPTION

Chemical structures are presented herein using the following general notation:
[structure]ₙ

This notation is intended to define a repeated chemical structure within a larger structure, or molecule. Use of brackets around a chemical structure, with a letter subscript “n” generally indicates that the structure is repeated “n” times. Letters other than “n” may be used, and in each case, the letter subscript stands for a positive integer of at least 3. Unless otherwise noted, there is no theoretical upper limit to the value of the subscript. The notation is intended to refer to all possible polymers, of any feasible size, having the structure. However, kinetic and thermodynamic circumstances of individual chemical reactions, such as viscosity, temperature, and monomer availability may limit the growth of polymers in specific cases.

The chemical structures in this disclosure may denote atomic composition of compounds and relative bonding arrangements of atoms in a chemical compound. Unless specifically stated, the geometric arrangement of atoms shown in the chemical structures is not intended to be an exact depiction of the geometric arrangement of every embodiment, and those skilled in the chemical arts will recognize that compounds may be similar to, or the same as, the illustrated compounds while having different molecular shapes or conformations. For example, the structures denoted herein may show bonds extending in one direction, while embodiments of the same compound may have the same bond extending in a different direction. Additionally, bond lengths and angles, Van der Waals surfaces, isoelectronic surfaces, and the like may vary among instances of the same chemical compound. Additionally, unless otherwise noted, the disclosed structures cover all stereoisomers of the represented compounds.

The inventors have made an aerogel that is a product of thermally treating a polymer having a plurality of carbon-nitrogen cyclic groups and a plurality of linking groups, each linking group covalently bonded to two cyclic groups, as a repeated structure. The polymer is a reaction product of a primary diamine and a formaldehyde, and is made by reacting the primary diamine and the formaldehyde, optionally in the presence of a solvent, at an elevated temperature to form an organogel. The organogel is subjected to a solvent removal process that preserves the morphology of the solvent-swelled polymer in a dry form, thus forming an aerogel. The aerogel may then be thermally treated to harden the aerogel.

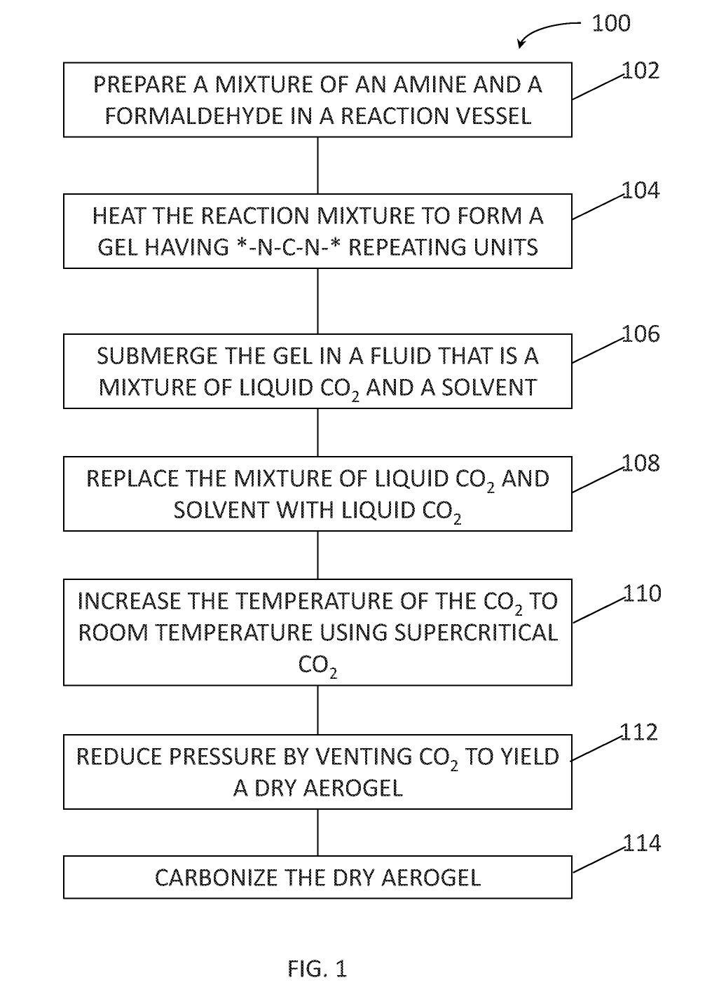

FIG. 1 is a flow diagram summarizing a method according to one embodiment. The method 100 may be used to form a dry organogel, an aerogel precursor, a soft aerogel, or a hardened aerogel. At 102, an amine and a formaldehyde are mixed in a vessel at a temperature less than about 30° C. to form a reaction mixture. One or more solvents may be added to the reaction mixture, or the amine and formaldehyde may be reacted without including a solvent.

The amine generally has the structure Q-(NH₂)ₓ where Q is an organic species with at least 5 carbon atoms, and x is 1, 2, or 3 so Q is a monovalent, divalent, or trivalent radical with the structure Q(−)ₓ. The reaction mixture formed at 102 will include at least some monomers where x is 2 or 3 (divalent or trivalent groups Q, referred to herein as “bridging groups”), but may also include some monomers where x is 1 (monovalent groups Q, referred to herein as “spacer groups”). The amine may include an aromatic group such that Q includes an aromatic group. The amine may be an amine-terminated polymer, where Q is a polymeric species. Q may be a bridging group having the general structure

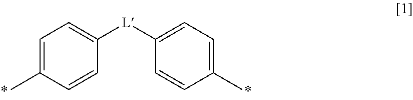

where L′ is a divalent group selected from the group consisting of O, S, N(R′), N(H), R″, and combinations thereof, wherein R′ and R″ independently comprise at least 1 carbon, and the starred bond denotes bonding to some other species, which may be a repeating or non-repeating species, not defined in structure [1]. The precursors used at 102 will have the starred bonds of structure [1] linked to amine nitrogens. Thus, precursors containing structure [1] have the structure

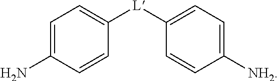

R′ and R″′, in each instance, may be an organic component independently selected from the group consisting of methyl, ethyl, propyl, isopropyl, phenyl, and combinations thereof. Other L′ groups in structure [1] include methylene (CH₂), isopropylidenyl (C(Me)₂), and fluorenylidenyl:

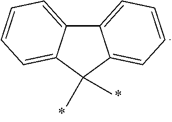

Other examples of divalent bridging groups Q include

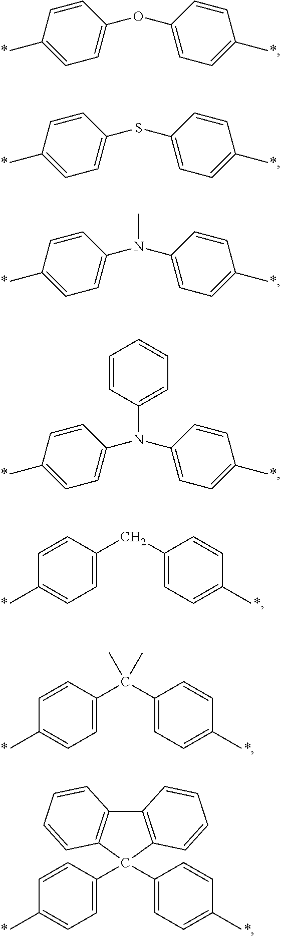

and combinations thereof. The precursors including the above examples of Q groups will be diamines including the structures above, where the starred bonds are linked to amine nitrogen atoms.

Q may include an electron withdrawing group such as a halogen containing group such as —CHₐX_{b} where a+b<4 and b>0, a sulfur containing group, an oxygen containing group, or an aromatic containing group. Q may be a trivalent bridging group as well. Examples of trivalent bridging groups Q include

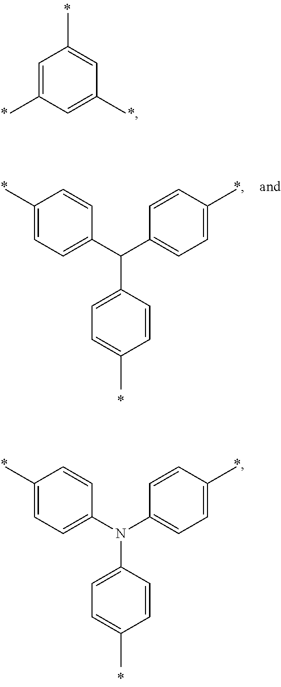

so that the precursors derived from such groups are triamines where the starred bonds of the above trivalent bridging groups are each linked to amine nitrogen atoms.

Precursors useful for the method 100 also include monoamines Q(NH₂), where Q is a spacer group having one of the following structures:

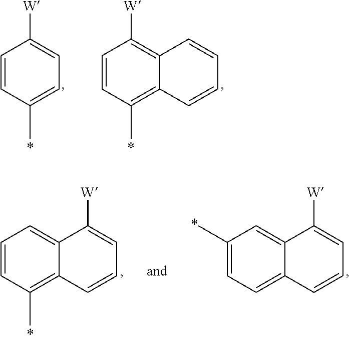

where in each case the starred bond is linked to an amine nitrogen atom. W′ is a monovalent radical selected from the group consisting of *—N(R¹)(R²), *—OR³, —SR⁴, wherein R¹, R², R³, and R⁴ are independent monovalent radicals comprising at least 1 carbon. Examples of spacer groups Q include:

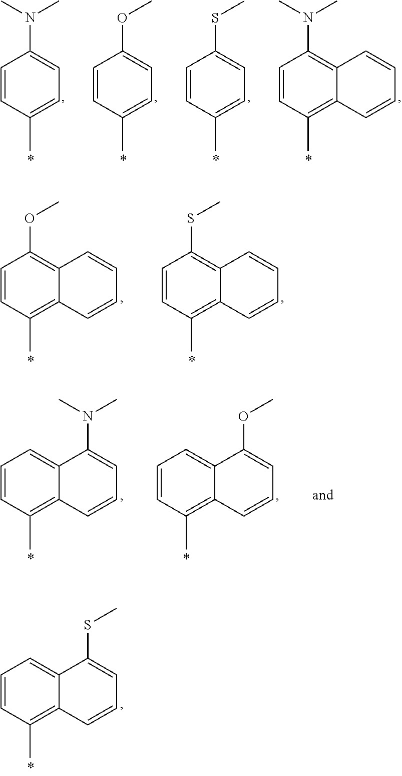

The spacer groups Q are used in amounts that depend on the characteristics of the desired polymer products, and are generally used in limited amounts compared to the divalent and trivalent precursors to allow polymer growth.

The divalent and trivalent bridging groups Q may include polymer or oligomer groups. The corresponding precursor for use in the method 100 may be a diamine-terminated polymer or oligomer, such as a diamine-terminated vinyl polymer, a diamine-terminated polyether, a diamine-terminated polyester, a diamine-terminated star polymer, a diamine-terminated polyaryl ether sulfone, a diamine-terminated polybenzoxazole polymer, a diamine-terminated polybenimidazole polymer, a diamine-terminated epoxy resin, a diamine-terminated polysiloxane polymer, a diamine-terminated polybutadiene polymer, and a diamine-terminated butadiene copolymer. Diamine-terminated polyethers are commercially available from suppliers such as Huntsman Corp. Diamine-terminated vinyl polymers include long-chain alkyl diamines which may be referred to as polyalkylene diamines, for example polyethylene diamine, polypropylene diamine, and other such polymer diamines. Diamine-terminated vinyl polymers also include long-chain polymer diamines with cyclic and/or aromatic components, such as diamine-terminated polystyrene. The diamine-terminated polymers and oligomers referred to above are commercially available, or may be readily synthesized through well-known reaction pathways.

Q may thus be a polymeric species such as a vinyl polymer chain, a polyether chain, a polyester chain, a polyimide chain, a polyamide chain, a polyurea chain, a polyurethane chain, a polyaryl ether sulfone chain, a polybenzoxazole chain, a polybenimidazole chain, an epoxy resin, a polysiloxane chain, a polybutadiene chain, and butadiene copolymer, or a combination thereof. Typically, a polymer group usable in these methods will have a molecular weight that is at least 1000 g/mole.

The molecular weight of a polymer mixture is usually expressed in terms of a moment of the molecular weight distribution of the polymer mixture, defined as

$${M}_{z} = \frac{\sum {m}_{i}^{z} - {n}_{i}}{\sum {m}_{i}^{z - 1} {n}_{i}} ,$$

where mᵢ is the molecular weight of the ith type of polymer molecule in the mixture, and nᵢ is the number of molecules of the ith type in the mixture, and z is at least 1. M₁ is also commonly referred to as Mₙ, the “number average molecular weight”. M₂ is also commonly referred to as M_{w}, the “weight average molecular weight”. The polymer mixtures used to obtain divalent polymer bridging groups in the materials described herein may have M₁ of at least about 1000 g/mol.

The molecular weight distribution of a polymer mixture may be indicated by a polydispersity ratio P_{z}, which may be defined as

$${P}_{z} = \frac{{M}_{z + 1}}{{M}_{z}} ,$$

where M_{z} is defined above. The polymer bridging groups used in embodiments described herein typically come from polymer molecule mixtures having a polydispersity ratio P₁ of about 1-3, for example about 2.

A precursor mixture for forming the aerogels described herein may include more than one precursor Q-(NH₂)ₓ and all precursors in the mixture may be divalent or trivalent, or the precursors may be mixture of monovalent (x=1), divalent (x=2), and trivalent (x=3) species, so long as some divalent or trivalent species are included in the mixture to promote formation of a polymer network.

In one example, an amine-terminated polyaryl ether sulfone may be prepared by reacting a bis-haloaryl sulfone, a diol such as bisphenol A, and an aminophenol such as 1,4-aminophenol in the presence of a base, generally as follows:

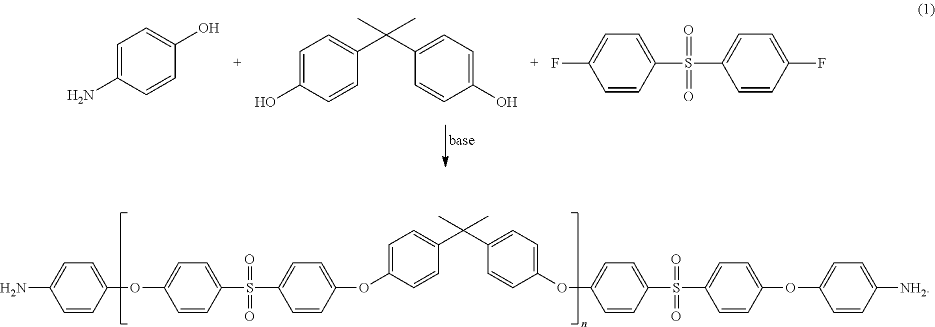

Reaction (1) may be performed in a dipolar aprotic solvent such as N-methyl-2-pyrrolidone (NMP), dimethylsulfoxide (DMSO), N,N-dimethylformamide (DMF), N,N-dimethylacetamide (DMA), propylene carbonate (PC), and/or propylene glycol methyl ether acetate (PGMEA). The sulfone and diol form a polymer terminated by halogen atoms, and the 1,4-aminophenol replaces the halogen atoms to leave an amine-terminated sulfone polymer. The reaction of the sulfone and diol is performed in the presence of a base, such as potassium carbonate. Molecular weight of the sulfone polymer molecules can be controlled by providing a slight excess of one reactant according to the Carothers equation. Addition of the aminophenol stops the polymerization reaction by removing the reactive halide ends.

Other amine-terminated polymers that may be used as precursors include bis-amino polyethers, which are commercially available or may be prepared by polymerizing an alkylene oxide to a polyalkylene glycol, and then aminating the polyalkylene glycol. A wide variety of reaction pathways are known for producing diamine-terminated polymers and oligomers for use as precursors in the method 100.

In general, polymer species Q useful for the reactions described herein may be thermoplastic, thermoset, quasi-thermoplastic, or any combination thereof. Quasi-thermoplastic polymers are those polymers that have a low degree of thermoplasticity derived by partially curing or cross-linking an initially thermoplastic polymer. Including thermoplastic components in the polymer adds toughness and resiliency to the eventual aerogel.

The solvents listed above in connection with reaction (1) may also be used as solvents for the method 100.

At 104, the reaction mixture of 102 is heated gently while mixing to form a gel. The gel is generally a chemical gel, such as an organogel, that includes a polymer dispersed in a solvent. The solvent may be any of the solvents described herein, or the solvent may be one or more excess precursors described above. The solvent generally maintains separation of polymer chains in the mixture to preserve the gel properties. The reaction may be performed at temperatures of 50° C. to 200° C.

Performing the reaction at lower temperatures, for example below about 80° C., forms a polyhemiaminal having the structures [2] and/or [3]

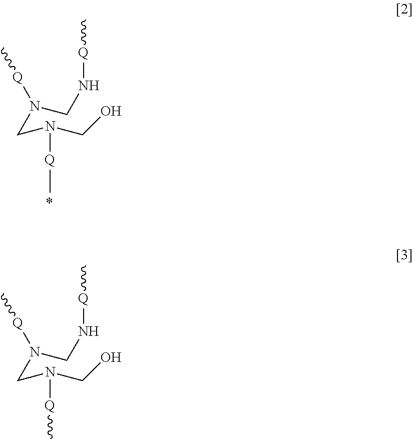

In structures [2] and [3] a hemiaminal unit having the structure *—N—C—N—C—N—C—O—* has bridging groups Q bonded to the nitrogen atoms, and the bridging groups Q link one hemiaminal unit to another. Q is defined above, and the wavy bonds denote links to a repeating chemical structure. In structures [2] and [3], the wavy bonds link the Q bridging group with a nitrogen atom of another hemiaminal group. The polyhemiaminals may also include structure [4], which may be referred to as a spacer structure:

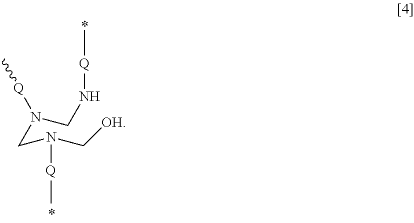

The polymers having structures [2] and [3], which may also include structure [4], and are generally hydrogen-terminated. The Q groups in structures [2]-[4] are shown as divalent groups, but as noted above a mixture of divalent and trivalent Q groups may be present, optionally with some monovalent Q groups.

Performing the reaction at temperatures above about 80° C. results in a polyhexahydrotriazine having the structures [5] and/or [6]

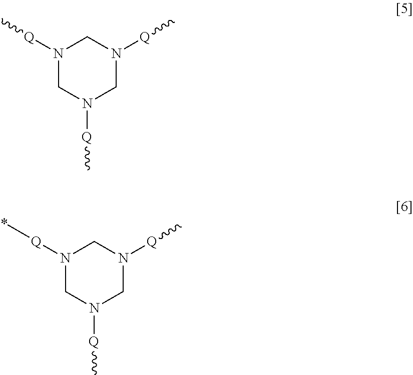

where Q, and the bond notations, are defined above. In addition, the polymers may include the hexahydrotriazine spacer structure [7]:

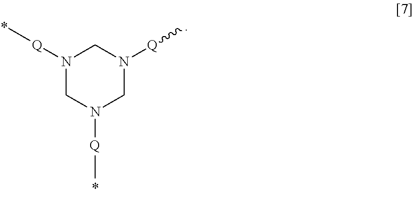

The Q groups in structure [5]-[7] are also shown a divalent groups, but may be trivalent, or a mixture of monovalent, divalent, and trivalent species as described above. The polymers having structures [5] and [6], which may also include structure [4], are generally hydrogen-terminated. The polymers formed generally have repeating *—N—C—N—* units with bridging groups Q linking them to form *-Q-N—C—N-Q-N—C—N-Q-* structures that may be cyclic or acyclic. The polyhexahydrotriazine and polyhemiaminal groups both have the repeated structure *—N—C—N—C—N—C—*, which is cyclic in the case of the polyhexahydrotriazine and may be acyclic in the case of the polyhemiaminal. The bridging groups Q may be divalent or trivalent, as described above. If the structure contains hydroxyl groups, hemiaminal units are present and the polymer will have structures of the form *-Q-N—C—OH. Such structures will take the form HO—C—N-Q-N—C—OH or the form *—N—C—N-Q-N—C—OH, depending on location in the network. If the structure does not contain hydroxyl groups, the *—N—C—N—* units are part of a hexahydrotriazine network that includes cyclic hexahydrotriazine units linked by the bridging groups Q.

The polymerization reaction proceeds through the hemiaminal stage at low temperatures, and at higher temperatures water is eliminated as the free amine and hydroxyl groups react to close the ring. The polymer formed at the hemiaminal stage may be referred to as a hemiaminal dynamic covalent network (HDCN). Thus, a single polymer chain, network, or mixture may include a mixture of structures [2]-[7] depending on how the reaction is performed. If the reaction is performed for an extended time at a temperature above about 80° C., the polymer will be a polyhexahydrotriazine. If the reaction temperature never exceeds 80° C., the polymer will be mostly, or entirely, polyhemiaminal. If the reaction is performed for a time at a temperature between 50° C. and 80° C., and then continued at a temperature above 80° C. for a limited time, a mixed polymer include hemiaminal and hexahydrotriazine units may be formed, along with any included spacer units.

As noted above, the reaction forms a gel, which is a polymer dispersed in a solvent. The properties of the gel formed at 104 will depend on the reaction performed, the precursors used, and the solvents used. In general, for subsequent operations of the method 100, the gel has sufficient structural strength to be removed from a reaction vessel and transferred to another vessel. The gel is subjected to a solvent removal process to form an aerogel. In the method 100, the solvent removal process is a supercritical CO₂ process. At 106, the gel is submerged in a fluid that is a mixture of a solvent and liquid CO₂. The solvent mixture may be circulated gently, and the temperature of the solvent mixture is maintained so the mixture remains liquid, for example at liquid CO₂ temperature. The gel is contacted with the solvent mixture for a time period to allow the solvent mixture to permeate the gel and replace the original solvent. Solvents that may be used with liquid CO₂ include alcohols such as methanol and ketones such as acetone. Usable solvents are low-boiling solvents compatible with the gel and miscible with the solvent used to form the gel. In general, solvents boiling at temperatures less than about 80° C. at atmospheric pressure are suited for use in this way.

At 108, the mixed solvent with liquid CO₂ is gradually replaced with liquid CO₂. Liquid CO₂ is flowed into the vessel containing the gel and the mixed solvent at liquid CO₂ temperature, and the mixed solvent is simultaneously withdrawn from the vessel. The overall liquid level in the vessel may be reduced during this operation to speed removal of higher boiling components.

At 110, after flowing liquid CO₂ into the vessel for a suitable time, for example about three residence times of the liquid volume, temperature of the mixture is gradually raised to a point above the critical temperature of the CO₂, and ultimately to room temperature. The vessel may be sealed during the heating process, or flow of CO₂ may be continued. When conditions in the vessel exceed the critical point of CO₂, flow of liquid CO₂ into the vessel is replaced by flow of supercritical CO₂ into the vessel. When a desired pressure is reached in the vessel, gas is vented to maintain the vessel pressure at the desired level. Pressure of the vessel is maintained at a pressure above the critical point of CO₂, 7.37 MPa, for example between 7.37 MPa and 9.65 MPa, as the gel is exposed to the supercritical CO₂, since vapor pressure of the solvent removed from the gel may mix with CO₂ to form a mixture with critical properties higher than that of pure CO₂. Liquid resulting from extraction of the solvent can be drained from the vessel.

At 112, after exposure to supercritical CO₂ is maintained for a time, flow of supercritical CO₂ into the vessel is stopped, and vessel pressure is gradually reduced to ambient pressure by venting CO₂ from the vessel. At this time, the vessel contains a dry aerogel.

At 114, the dry aerogel is thermally treated to harden the aerogel. The thermal treatment is performed under an oxygen-free atmosphere where the aerogel is heated to 400° C.-1,800° C. The thermal treatment process carbonizes the aerogel, at least partially, to increase hardness of the aerogel. The carbonization process is thought to remove hydrogen from the aerogel without decomposing the carbon structure. After a desired degree of carbonization is accomplished, the carbonized aerogel is removed from the vessel. The gel may be partly or completely carbonized, depending on the needs of specific embodiments. Partly carbonizing the gel preserves some of the pliability and resilience of the original aerogel, at the expense of toughness and hardness.

In an alternate embodiment, solvent is removed from the gel by a vacuum process. The gel is placed in a vessel that is then sealed and provided with vacuum and a flow of a drying gas to maintain a pressure lower than atmospheric pressure for removing solvent from the gel. Maintaining a pressure less than about 500 Torr, for example, provides enhanced solvent removal from the aerogel, which would otherwise dry only slowly, or not at all, due to retention of solvent in the spaces between polymer chains in the gel. Heat may be provided to maintain the gel at a temperature up to about 25° C. (i.e. about room temperature) if solvent evaporation cools the gel.

The resulting aerogel is a carbonization product of a polymer containing hexahydrotriazine and/or hemiaminal groups linked by the bridging groups described above. The aerogel includes repeating units that have N—C—N bonds, and that are linked by bridging groups that may be divalent or trivalent, as described above. The aerogel may include carbonization products of the spacer units described above. The aerogels formed by the methods described herein have improved toughness, but also have the ability to be chemically altered and/or recycled. In one case, the aerogel can be depolymerized using warm acid, and then remade using the resulting monomer mixture. In another case, the surface of the resulting aerogel can be functionalized by reacting additional monomers with nitrogen atoms along the polymer network.

An exemplary process of forming a HDCN aerogel uses paraformaldehyde and 4,4′-oxydianiline as precursors. Paraformaldehyde (3.0 equiv 0.090 g, 3.0 mmol), and 4,4′-oxydianiline (ODA, 0.200 g, 1.0 mmol) were weighed out into a 2-Dram vial equipped with a stirbar inside a N₂- filled glovebox and tetrahydrofuran was added (THF, 2.40 mL, 0.42 M). The reaction mixture was removed from the glovebox, and set up to heat in an oil bath set to 60° C. The reaction was allowed to heat for 12 hours before the solution solidified and residual THF was removed in vacuo. The resulting HDCN material was a white, opaque, hard material that showed porosity/voids by SEM.

An example process by which a carbon-based aerogel may be formed uses similar materials. If performed, this process will yield an aerogel containing hexahydrotriazine units. Paraformaldehyde (2.5 equiv 0.075 g, 2.5 mmol), and 4,4′-oxydianiline (ODA, 0.200 g, 1.0 mmol) are weighed out into a 2-Dram vial equipped with a stirbar inside a N₂-filled glovebox and N-methylpyrrolidone was added (NMP, 3.0 mL, 0.33 M). The reaction mixture is removed from the glovebox, and set up to heat in an oil bath set to 50° C. The reaction mixture is allowed to stir for 24 h (during which the polymer begins to gel out in the NMP solution and stirring is ceased). The solution is then allowed to cool to room temperature. Next, the as-formed gel is placed in a Polaron autoclave in 100 mL methanol at 20° C. Liquid carbon dioxide is then introduced with a slight venting of gas. Once the autoclave is filled with liquid CO₂ and methanol, they are allowed to mix together and permeate throughout the aerogels for 24 h. The methanol-carbon dioxide mixture is then replaced with pure liquid carbon dioxide by slowing venting and continuously introducing additional liquid carbon dioxide over about 4-6 h. Next, the system is closed and the temperature raised to 36° C. When the pressure reaches 7.37 MPa, the outlet to the autoclave is carefully opened and the carbon dioxide vented while keeping the pressure between 7.37 and 9.65 MPa. The carbon dioxide is then vented over 8 h to afford an HDCN-containing aerogel. Following supercritical CO₂ drying, the HDCN-containing aerogel is placed into a furnace inside an electric clamshell furnace. A controlled flow of an inert gas on the order of 200 sccm of nitrogen or argon is flowed through the furnace throughout the whole process. The furnace is then heated to a target temperature (400-1800° C.). The sample is left in the furnace at temperature for 1-12 h. Following carbonization, the furnace is cooled to room temperature to yield an HDCN-containing carbon-based aerogel.

While the foregoing is directed to embodiments of the present invention, other and further embodiments of the invention may be devised without departing from the basic scope thereof, and the scope thereof is determined by the claims that follow.

1. An aerogel that is a carbonization product of a polymer with a plurality of hexahydrotriazine groups and a plurality of bridging groups, the polymer derived from a reactant set consisting of (i) a formaldehyde and (ii) at least one diamine, or a combination of at least one diamine and at least one triamine, wherein each of the bridging groups is covalently bonded to two or more of the hexahydrotriazine groups and has the structure Q(−)ₓ, wherein each x is independently 2,or 3, and wherein if x is 2, Q is selected from the group consisting of a polyester, a polyimide, a polyamide, a polyurea, a polyurethane, a polyaryl ether sulfone, a polybenzoxazole, a polybenzimidazole, an epoxy resin, a polysiloxane, a polybutadiene, butadiene copolymer, and a combination thereof.

2. (canceled)

3. The aerogel of claim 1, wherein x is 3 and Q includes an aromatic group.

4. (canceled)

5. (canceled)

6. The aerogel of claim 1, wherein the polymer also has a plurality of spacer groups, each spacer group covalently bonded to one of the hexahydrotriazine groups.

7. The aerogel of claim 6, wherein a mass ratio of the bridging groups to the spacer groups is at least 10:1.

8. The aerogel of claim 6, wherein each spacer group has the structure—Q, wherein Q includes an electron-withdrawing component.

9. An aerogel that is a carbonization product of a polymer with a plurality of hemiaminal groups having the structure 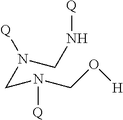
and a plurality of bridging groups, the polymer derived from a reactant set consisting of (i) a formaldehyde and (ii) at least one diamine, or a combination of at least one diamine and at least one triamine, wherein each of the bridging groups is covalently bonded to two or more of the hemiaminal groups and has the structure Q(−)ₓ, wherein each x is independently 2, or 3, and wherein if x is 2, Q is selected from the group consisting of a polyester, a polyimide, a polyamide, a polyurea, a polyurethane, a polyaryl ether sulfone, a polybenzoxazole, a polybenzimidazole, an epoxy resin, a polysiloxane, a polybutadiene, butadiene copolymer, and a combination thereof.

10. (canceled)

11. (canceled)

12. The aerogel of claim 9, wherein the polymer also has a plurality of spacer groups, each spacer group covalently bonded to one of the hemiaminal groups.

13. The aerogel of claim 12, wherein a mass ratio of the bridging groups to the spacer groups is at least 10:1.

14. The aerogel of claim 12, wherein each spacer group has the structure_—Q, wherein Q includes an electron-withdrawing component.

15. A method of making an aerogel, comprising:
forming a reaction mixture consisting of a solvent set consisting of one or more unreactive solvents and a reactant set consisting of (i) a formaldehyde and (ii) at least one diamine, or a combination of at least one diamine and at least one triamine, wherein the at least one diamine is selected from the group consisting of a polyester, a polyimide, a polyamide, a polyurea, a polyurethane, a polyaryl ether sulfone, a polybenzoxazole, a polybenzimidazole, an epoxy resin, a polysiloxane, a polybutadiene, butadiene copolymer, and a combination thereof;
reacting the at least one diamine and the formaldehyde in the solvent set to form a polymer with a plurality of hemiaminal groups having the structure 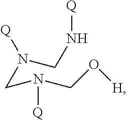
or a plurality of hexahydroatriazine groups having the structure 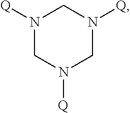
or combinations thereof;
subjecting the polymer to a supercritical CO₂ solvent removal process; and
thermally hardening the polymer to form an aerogel.

16. The method of claim 15, wherein the polymer is an organogel.

17. The method of claim 15, wherein the polymer has a plurality of bridging groups, each bridging group covalently bonded to two or more of the hemiaminal groups, hexahydrotriazine groups, or combinations thereof.

18. The method of claim 17, wherein the at least one diamine includes an aromatic group.

19. (canceled)

20. (canceled)

21. The aerogel of claim 1, wherein the at least one diamine is selected from the group consisting of a polyethylene, a polypropylene, and a polystyrene.

22. The aerogel of claim 9, wherein the at least one diamine is selected from the group consisting of a polyethylene, a polypropylene, and a polystyrene.

23. The aerogel of claim 9, wherein Q includes an aromatic group.

24. The aerogel of claim 15, wherein the at least one diamine is selected from the group consisting of a polyethylene, a polypropylene, and a polystyrene.

25. The aerogel of claim 15, wherein the wherein the polymer also has a plurality of spacer groups, each spacer group is covalently bonded to one of the hexahydrotriazine groups or one of the hemiaminal groups.
